(19) United States
(12) Patent Application Publication
(10) Pub. No.: US 2006/0290148 A1
(43) Pub. Date: Dec. 28, 2006

(54) Safety button

(76) Inventor: Joseph Talpe, AVELGEM-KERKHOVE (BE)

Correspondence Address: SUGHRUE MION, PLLC, 2100 PENNSYLVANIA AVENUE, N.W., SUITE 800, WASHINGTON, DC, 20037, US

(21) Appl. No.: 10/595,109

(22) PCT Filed: Aug. 17, 2004
(86) PCT No.: PCT/EP04/09254

§ 371 Date: Feb. 17, 2006

(30) Foreign Application Priority Data
Aug. 21, 2003 (BE) 2003/0456

(51) Int. Cl. E05B 3/00

(52) U.S. Cl. 292/336.3

(57) ABSTRACT

Element (1) for opening and/or closing doors, gates or windows, comprising a first part (2) designed to operate a closing mechanism by rotation, a second rotary part (3) designed to transfer a rotary motion to the first part (2), the rotary knob (1) being provided with one or several push buttons (4), so that when at least one push button (4) is pushed, the rotary motion of the second part (3) is transferred to the first part (2). With this element (1), two operations have to be performed, namely pushing a push button and performing a rotary motion of the element (1) in order to open a door and suchlike, because of which it will become practically impossible for children to open a door by accident.

This invention relates to an element for opening and/or closing doors, gates or windows, comprising a first part designed to operate a closing mechanism by rotation, and a second rotatable part designed to transfer a rotary motion to the first part.

In this patent application, by element is meant: rotary knobs, rotatable parts, handles or levers which may be used to open and/or close a door, gate or window.

Elements to operate closing mechanisms are known and are most of the time rotatable, against the force exerted by a spring, in order to remove a pin and suchlike extending sideways, from a recess in a door post and suchlike in order to open the gate or the door in accordance with the principle of the mechanism with which most inner doors are provided.

However, doors and gates provided with the elements described above are easy to be opened by children. Because of this, these elements have the disadvantage that they cannot be used to prevent children from entering by accident.

The disadvantage described above is partly resolved in the publication of the German patent DE 199 57 697. In here protection is claimed for an element, more particularly a rotary knob able to move forward against the force exerted by a spring, after which the door can be opened by a rotary motion, in order to prevent doors from being opened by children in an undesirable manner.

However, the knob described in DE 199 57 697 has the disadvantage that it is possible to open doors only in one direction. At the same time the possibility still exists that children may open the door by accident by leaning against the knob and turning it.

The purpose of this invention is to provide an element for opening and/or closing doors, gates or windows not having the drawbacks mentioned above.

The purpose of the present invention is obtained by providing an element for opening and/or closing doors, gates or windows, comprising a first part designed to operate a closing mechanism by rotation, and a second rotatable part designed to transfer a rotary motion to the first part, the element being provided with one or several push buttons, such that when pushing at least one button the rotary motion of the second part will be transferred to the first part.

By carrying out the element in such a manner, it has the advantage that doors, gates or windows may be opened in different directions, preferably by pulling, pushing or sliding. At the same time two operations, namely pushing a push button and giving a rotary motion to the element, have to be performed in order to open a door and suchlike, because of which it will become practically impossible for children to open a door by accident.

In a preferred embodiment of the element according to the invention, the second element may rotate freely with respect to the first part if none of these buttons is pushed. Because of this it is practically impossible for children to open doors equipped with an element according to the invention.

In a more particular preferred embodiment of the element according to the invention, the element comprises a connecting piece that is provided with bulges and one or several push buttons are acting on this bulges in recesses which have been provided in the first part. Because of this it is possible to transfer the rotary motion of the second part to the first part.

In a particularly advantageous embodiment of the element according to the invention, the push buttons are provided with an inclined plane, which in case one or several push buttons are pushed, will act on one or several inclined planes provided on the said connecting piece.

In a particularly preferred embodiment of the element according to the invention, the element is provided with at least two push buttons, whereby pushing at least one of the push buttons, the rotary motion of the second part is transferred to the first part. Preferably, the push buttons are located at the outer circumference of the second part. By designing the element in such a manner, doors may be opened independently from the position of the element.

In a most particular embodiment of the element according to the invention, a spring has been provided between the connecting piece and the first part, so that the push button is movable against the force of the spring. Preferably a total force of at least 25 Newton has to be exerted on one or several push buttons in order to make the said bulges engage the said recesses. In a more particular embodiment, this total force amounts to 50 Newton.

In a preferred embodiment of the element according to the invention, the said element is made of synthetic material or metal such as, for instance, aluminium or stainless steel.

In a most preferred embodiment of the element according to the invention, the said element (1) is a rotary knob.

In order to further explain the characteristics of the present invention and to show additional advantages and particulars, now a more detailed description of the rotary knob will follow. It may be obvious that in the following description nothing may be interpreted as a restriction of the protection claimed for in the claims of this invention.

By means of reference numbers, reference is made to the attached drawings in which:

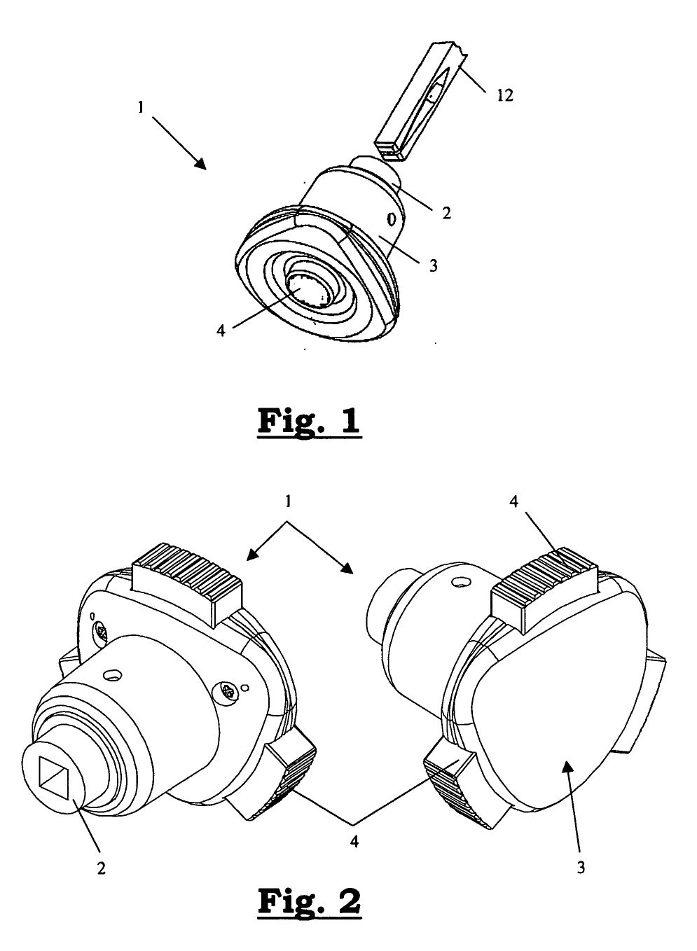

FIG. 1 is representing a perspective representation of a rotary knob according to the invention provided with one push button;

FIG. 2 is representing a perspective representation of a rotary knob according to the invention provided with three push buttons;

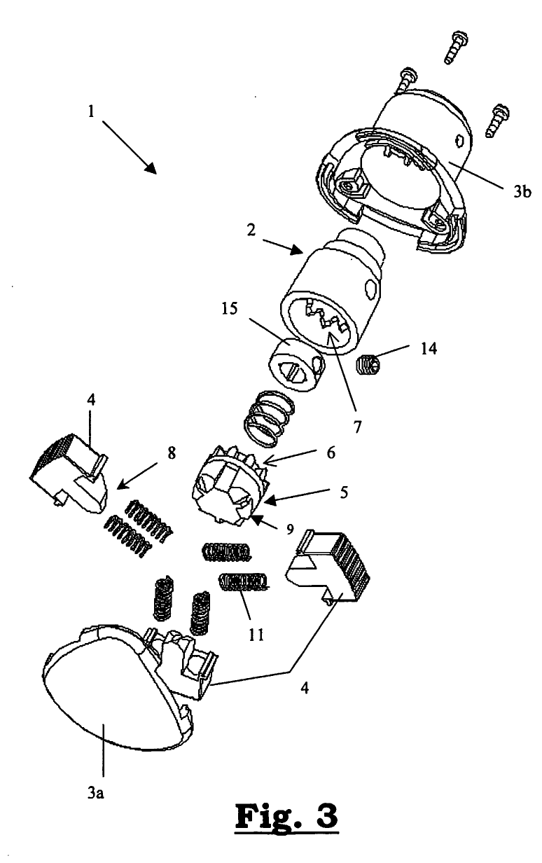

FIG. 3 is representing an exploded view of the rotary knob represented in drawing 2;

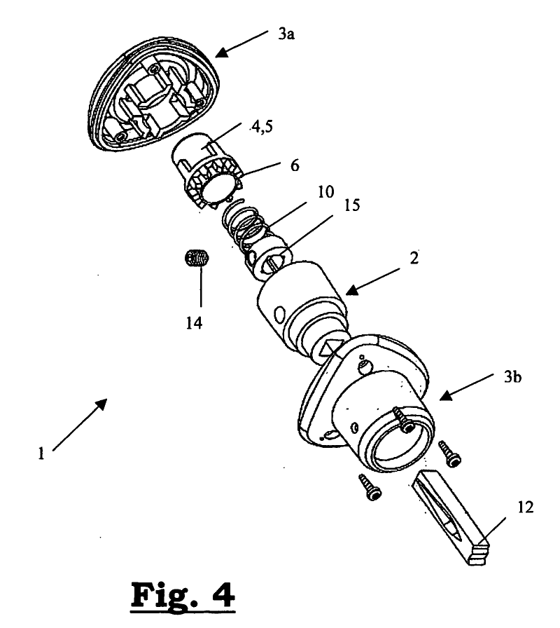

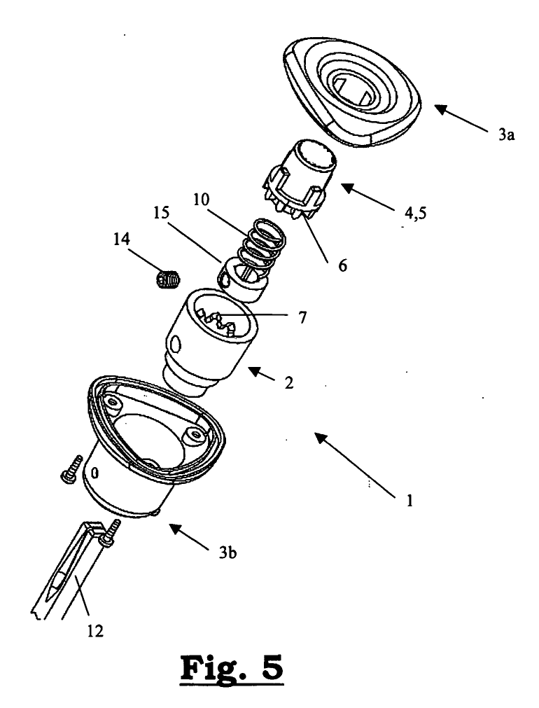

FIGS. 4 and 5 are representing exploded views of the rotary knob represented in drawing 1.

The element (1) according to the invention, more particularly a rotary knob (1) for opening and/or closing doors, gates or windows, comprises a first part (2), designed to operate a closing mechanism by rotation, and a second rotatable part (3), provided to transfer a rotary motion to the first part (2).

The second part consists of a housing (3b) made of synthetic material that may be closed off by a cover (3a). The closing mechanism is operated by means of pin (12) mounted on the first part (2).

The pin (12) is secured to the first part (2) preferably by means of a metallic ring and a regulating screw (14).

Depending on the embodiment, the rotary knob (1) is provided with one or several push buttons (4). As long as these push buttons (4) are not pushed the second part (3) is freely rotatable with respect to the first part (2). Now, when one push button (4) is pushed, the rotary motion of the second part (3) is transferred to the first part (2) and a door may be opened for instance.

In order to transfer the rotary motion of the second part (3) to the first part (2), the rotary knob (1) comprises a connecting piece (5) provided with bulges (6). In order to make it more difficult for children to open a door, a spring (10) is provided between the connecting piece (5) and the first part, so that the push buttons (4) are movable against the force of a spring.

The spring (10) may be mounted on the pin (12) and by making use of this space, the rotary knob (1) according to the invention, has the advantage that the rotary knob (1) can take longer pins.

With the rotary knob (1) with one central push button (4), represented in the FIGS. 1, 4 and 5, the push button (4) is in fact the said connecting piece (5). When this central push button is pushed it moves forward axially against the force of a spring, because of which the bulges (6) will engage the recesses (7) provided in the first part (2). If now, at the same time, a rotary motion is performed, a door can be opened.

The rotary knob (1) represented in the FIGS. 2 and 3 has been provided with three push buttons (4) situated on the outer circumference of the second part (3), which may be pushed against the force of a spring supplied by the presence of the springs (11). Now in order to transfer the rotary motion from the second part (3) to the first part (2), the push buttons (4) of this embodiment are provided with an inclined plane (8) that, when the push button (4) is pushed, will engage an inclined plane (9) provided on the connecting piece (5). Now, when one or several push buttons (4) are pushed, the connecting piece (5) will move axially forward against the force of a spring and the bulges (6) of the connecting piece (5) will engage the recesses (7) provided in the first part (2).

Now, in order to make the said bulges (6) engage the recesses (7) of the first part (2), preferably a total force of at least 25 Newton should be exerted on the push buttons (4).

To open a door, for instance, by means of an element (1) according to the invention, two operations have to be performed to open the door, namely pushing at least one push button (4) and performing a rotary motion of the element (1). Because of this, it is practically impossible for children to open the door by accident.

1. Element (1) for opening and/or closing doors, gates or windows, comprising a first part (2) designed to operate a closing mechanism by rotation, and a second rotatable part (3) designed to transfer a rotary motion to the first part (2), characterized in that the element (1) has been provided with one or several push buttons (4), so that, when at least one button (4) is pushed, the rotary motion of the second part (3) is transferred to the first part (2).

2. Element (1) for doors, gates or windows according to claim 1, characterized in that, when none of these push buttons (4) is pushed, the second part (3) is freely rotatable with respect to the first part (2).

3. Element (1) for doors, gates or windows according to claim 1, characterized in that the element (1) comprises a connecting piece (5) provided with bulges (6), so that when pushing one or several push buttons (4), these bulges (6) will engage recesses (7) provided in the first part (2).

4. Element (1) for doors, gates or windows according to claim 3, characterized in that the push buttons (4) have been provided with an inclined plane (8) which, when one or several push buttons (4) are pushed, will engage one or several inclined planes (9) provided on the said connecting piece (5).

5. Element (1) for doors, gates or windows according to claim 1, characterized in that the element (1) has been provided with at least two push buttons (4), so that when pushing at least one push button (4) the rotary motion of the second part (3) will be transferred to the first part (2).

6. Element (1) for doors, gates or windows according to claim 3, characterized in that between the connecting piece (5) and the first part (2) a spring (10) has been provided, so that the push button (4) is movable against the force of the spring.

7. Element (1) for doors, gates or windows according to claim 6, characterized in that on one or several push buttons (4) a total force of at least 25 Newton has to be exerted in order to make the said bulges (6) engage the said recesses (7).

8. Element (1) according to claim 1, characterized in that the said element (1) is made of synthetic material or of metal.

9. Element (1) according to claim 1, characterized in that the said element (1) is a rotary knob.
